(19) United States
(12) Patent Application Publication
(10) Pub. No.: US 2008/0259216 A1
(43) Pub. Date: Oct. 23, 2008

(54) COLOR SIGNAL CONVERTING APPARATUS, VIDEO DISPLAY APPARATUS INCLUDING THE SAME, AND COLOR SIGNAL CONVERTING METHOD

(75) Inventors: Riichiro Yoshida, Tokyo (JP); Ritsuo Yoshida, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/103,327

(22) Filed: Apr. 15, 2008

(30) Foreign Application Priority Data
Apr. 20, 2007 (JP) 2007-112222

(51) Int. Cl. H04N 9/64; H04N 5/66

(52) U.S. Cl. 348/649; 348/739; 348/E09.037; 348/E05.133

(57) ABSTRACT

According to one embodiment, a color signal converting apparatus includes: a minimum value detecting section detecting a minimum value signal having a smallest value among a plurality of input color signals; a difference extracting section extracting a difference between the minimum value signal detected by the minimum value detecting section and a reference value; a difference adding section adding the difference extracted by the difference extracting section to each of the plural color signals; and a saturation converting section converting saturation of each of the plural color signals to which the difference is added, according to a ratio of brightness of the plural input color signals and brightness of the plural color signals to which the difference is added by the difference adding section.

### CROSS-REFERENCE TO RELATED APPLICATIONS

This application is based upon and claims the benefit of priority from Japanese Patent Application No. 2007-112222, filed Apr. 20, 2007, the entire contents of which are incorporated herein by reference.

### BACKGROUND

1. Field

One embodiment of the invention relates to a color signal converting apparatus, a video display apparatus including the same, and a color signal converting method.

2. Description of the Related Art

Conventionally, there has been known a video display apparatus (for example, a digital broadcast receiving apparatus and the like) including a thin display panel such as a liquid crystal display or a plasma display panel. Video display apparatuses of this type have recently made a remarkable progress in display performance of their display panels, and those including a display panel which can display a wider range of colors than could be displayed before have increasingly become available.

Since a color signal not displayable by display performance of a display panel is sometimes input to a video display apparatus, a conventional video display apparatus processes such a color signal into a color signal conforming to a dynamic range of the display panel by detecting the maximum value of three RCB color signals and attenuating the maximum value to a level displayable on the display panel. Regarding this, Japanese Patent Application Publication (KOKAI) No. 2006-179978 (patent document 1), for instance, discloses a video signal processing apparatus which suppresses the maximum signal level to a predetermined level higher than a suppression start level and by commonly using this suppression gain, suppresses the levels of the other color signals, thereby suppressing the levels of the color signals without breaking white balance.

With the aim of reproducing more vivid color by making use of such display performance of a display panel, Color Management Extended-gamut YCC Color Space for Video Applications IEC61966-2-4: xvYCC has recently been established. This xvYCC is a standard that realizes a wider color gamut by using a YCC gamut not in use conventionally, and yet maintains compatibility with conventional ITU-BT709 in terms of a digital video transmission format.

Further, in the HDMI (High-Definition Multimedia Interface) standard, Version 1.3 has recently been established. Version 1.3 of the HDMI standard supports xvYCC. Therefore, a YCC signal compliant with xvYCC is output from a video signal output apparatus such as a video camera and a DVD (Digital Versatile Disk) recorder, and the YCC signal is input via an HDMI cable to a video display apparatus, which then is capable of displaying video by using the YCC signal.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the configuration of a color signal converting apparatus according to a first embodiment of the invention;

FIG. 2(a) to FIG. 2(c) are exemplary views schematically showing an example of the operation contents of the color signal converting apparatus according to the first embodiment, FIG. 2(a) showing RGB of an input RGB signal, FIG. 2(b) showing RGB of the input RGB signal with a difference added thereto, and FIG. 2(c) showing RGB of the RGB signal whose saturation has been converted;

FIG. 3 is an exemplary block diagram showing the configuration of a color signal converting apparatus according to a second embodiment of the invention;

FIG. 4(a) to FIG. 4(e) are exemplary views schematically showing an example of the operation contents of the color signal converting apparatus according to the second embodiment, FIG. 4(a) showing RGB of an input RGB signal, FIG. 4(b) showing RGB of the RGB signal having performed complementary color conversion, FIG. 4(c) showing RGB of the RGB signal with a difference added thereto, FIG. 4(d) showing RGB of the RGB signal whose saturation has been converted, and FIG. 4(e) showing RGB of the RGB signal having performed complementary color conversion;

FIG. 5 is an exemplary block diagram showing the configuration of a color signal converting apparatus according to a third embodiment of the invention;

FIG. 6 is an exemplary block diagram showing the configuration of a video display apparatus according to an embodiment of the invention;

FIG. 7 is an exemplary view showing expressions for a transmission γ characteristic and expressions for a reception γ characteristic in the embodiment;

FIG. 8 is an exemplary graph showing the transmission γ characteristic and the reception γ characteristic in the embodiment;

FIG. 9 is an exemplary graph showing a γ characteristic of a γ correction unit in the embodiment;

FIG. 10 is an exemplary block diagram showing the configuration of another color signal converting apparatus in the embodiment; and

FIG. 11 is an exemplary block diagram showing the configuration of still another color signal converting apparatus in the embodiment.

### DETAILED DESCRIPTION

Various embodiments according to the invention will be described hereinafter with reference to the accompanying drawings. In general, according to one embodiment of the invention, a color signal converting apparatus includes: a minimum value detecting section detecting a minimum value signal having a smallest value among a plurality of input color signals; a difference extracting section extracting a difference between the minimum value signal detected by the minimum value detecting section and a reference value; a difference adding section adding the difference extracted by the difference extracting section to each of the plural color signals; and a saturation converting section converting saturation of each of the plural color signals to which the difference is added, according to a ratio of brightness of the plural input color signals and brightness of the plural color signals to which the difference is added by the difference adding section.

Further, a video display apparatus includes: a video display panel displaying video; a video signal processing section applying signal processing appropriate for the video display panel to an input video signal; an RGB signal converting section converting the video signal processed by the video signal processing section, into an RGB signal; and a color signal converting section applying conversion processing to the RGB signal resulting from the conversion by the RGB signal converting section. The color signal converting section includes: a minimum value detecting section detecting a minimum value signal having a smallest value in the input RGB signal; a difference extracting section extracting a difference between the minimum value signal detected by the minimum value detecting section and a reference value; a difference adding section adding the difference extracted by the difference extracting section to each of RGB color signals composing the RGB signal; and a saturation converting section converting saturation of each of the RGB color signals to which the difference is added, according to a ratio of brightness of the input RGB signal and brightness of the RGB color signals to which the difference is added by the difference adding section.

Further, a color signal converting method includes: detecting a minimum value signal having a smallest value among a plurality of input color signals; extracting a difference between the detected minimum value signal and a reference value; adding the extracted difference to each of the plural color signals; and converting saturation of each of the plural color signals to which the difference is added, according to a ratio of brightness of the plural input color signals and brightness of the plural color signals to which the difference is added.

### First Embodiment of a Color Signal Converting Apparatus

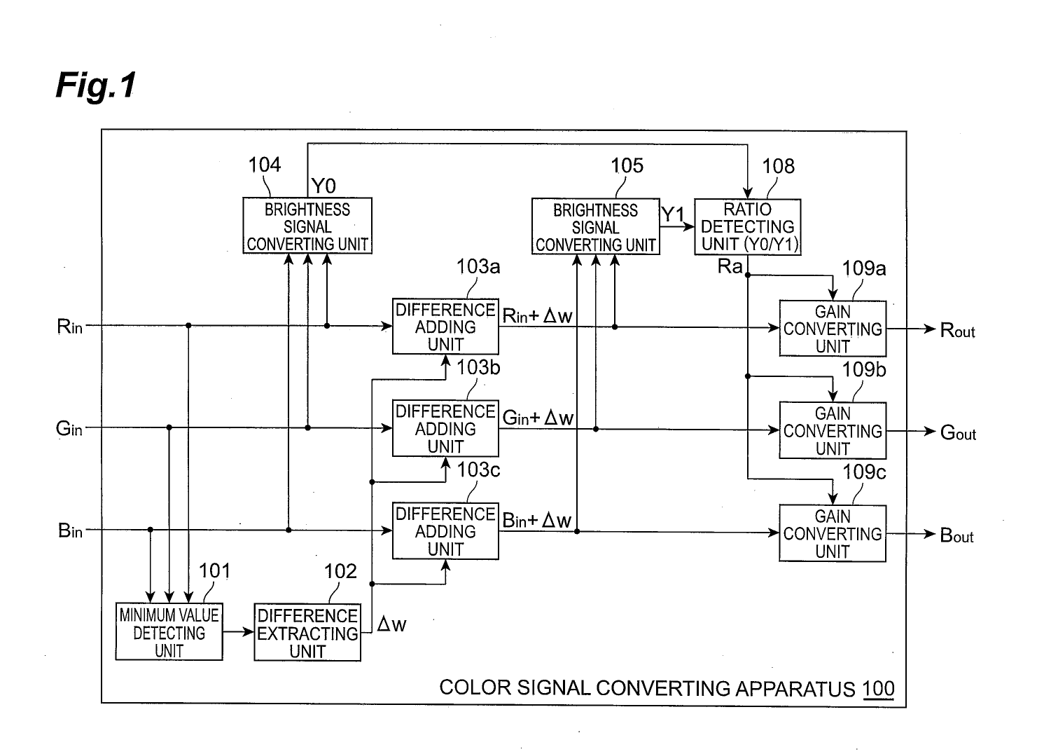

FIG. 1 is a block diagram showing the configuration of a color signal converting apparatus 100 according to a first embodiment of the invention. When an RGB signal having an RGB value smaller than “0” is input, the color signal converting apparatus 100 applies later-described saturation conversion to the RGB signal, thereby adjusting the RGB value to a value within a range of “0” to “1”.

The color signal converting apparatus 100 includes a minimum value detecting unit 101, a difference extracting unit 102, and difference adding units 103a, 103b, 103c, as shown in FIG. 1. The color signal converting apparatus 100 further includes brightness signal converting units 104, 105, a ratio detecting unit 108, and gain converting units 109a, 109b, 109c.

The minimum value detecting unit 101 detects a color signal with a minimum value (minimum value signal) among three input color signals (an R signal, a G signal, and a B signal). The difference extracting unit 102 extracts a difference between the minimum value signal, which is detected by the minimum value detecting unit 101, and a reference value “0”.

In this case, the difference extracting unit 102 performs an operation (h=0−RGB value) to calculate a difference h between the reference value “0” and an RGB value of the minimum value signal, and outputs a difference signal Δw (=0−RGB value) when the difference h is equal to or more than “0”. On the other hand, when the difference h is smaller than “0”, which means that the RGB value of the minimum value signal is positive, no saturation conversion is necessary, and therefore, the difference extracting unit 102 outputs a difference signal Δw (=0). In this manner, the color signal converting apparatus 100 operates in whichever case where the RGB value is positive or where the RGB value is negative.

The difference adding units 103a, 103b, 103c are similar adders, and add the difference signal Δw to the input R signal (Rin), G signal (Gin), and B signal (Bin) to output an R signal (Rin+Δw), a G signal (Gin+Δw), and a B signal (Bin+Δw) which result from the difference addition, respectively.

The brightness signal converting unit 104, which is a first brightness signal converting section, performs a matrix operation on the input R signal (Rin), G signal (Gin), and B signal (Bin) to calculate a brightness signal Y0. In this case, the brightness signal Y0 is calculated according to the following expression 1. The brightness signal converting unit 104 includes an adder for the matrix operation.

Y0=Ka×Rv+Kb×Gv+Kc×Bv (Ka, Kb, and Kc are constants, Ka+Kb+Kc=1, and Rv, Gv, and Bv are RGB values of the R signal, the G signal, and the B signal respectively) Expression 1

The brightness signal converting unit 105, which is a second brightness signal converting section, performs the same matrix operation as that performed by the brightness signal converting unit 104, on the R signal (Rin+Δw), the G signal (Gin+Δw), and the B signal (Bin+Δw) which result from the difference addition, thereby calculating a brightness signal Y1.

The ratio detecting unit 108 performs an operation according to the expression 2 to detect a ratio of the brightness signals Y0, Y1 (a brightness ratio Ra).

Ra=Y0/Y1 Expression 2

If Y0=“0” and the difference signal Δw=“0”, the brightness signal Y1 is “0”, which means black level, and at this time, the ratio detecting unit 108 outputs “1”.

Further, if the input RGB signal is a color signal within a color gamut of a later-described display panel 510, the difference signal Δw=“0” and the brightness signal Y0=Y1, and therefore, the brightness ratio Ra=“1”. If the input RGB signal is a color signal out of the color gamut of the display panel 510 and one of Rin, Gin, and Bin has a negative RGB value, the difference signal Δw>0. Therefore, the brightness ratio Ra becomes smaller than “1” according to the expression 3.

Ra=Y0/Y1=Y0/Y0+Δw(<1) Expression 3

According to the brightness ratio Ra detected by the ratio detecting unit 108, the gain converting units 109a, 109b, 109c apply gain conversion to the R signals (Rin+Δw), the G signal (Gin+Δw), and the B signal (Bin+Δw) which result from the difference addition, and output an R signal (Rout), a G signal (Gout), and a B signal (Bout) respectively. The gain converting units 109a, 109b, 109c have a function as a saturation converting section converting saturations of the color signals by the gain conversion.

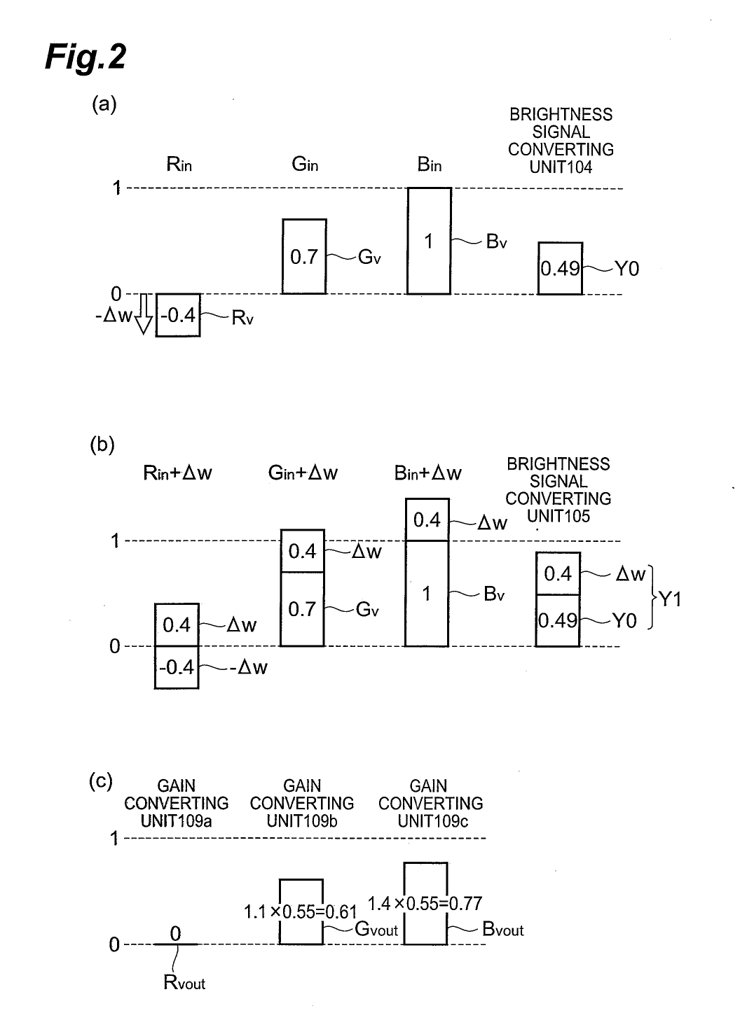

Next, the operation contents of the color signal converting apparatus 100 as configured above will be described with reference to FIG. 2(a) to FIG. 2(c). FIG. 2(a) to FIG. 2(c) are views schematically showing an example of the operation contents of the color signal converting apparatus 100.

It is assumed that three R signal (Rin), G signal (Gin), and B signal (Bin) as shown in FIG. 2(a) are input to the color signal converting apparatus 100. In this case, Rin has a negative RGB value Rv (=−0.4). Further, Gin has a positive RGB value Gv (=0.7), and Bin has a positive RGB value Bv (=1).

At this time, the minimum value detecting unit 101 detects Rin as the minimum value signal from the three R signal (Rin), G signal (Gin), and B signal (Bin). Further, since the RGB value of Rin is negative and the difference h is positive, the difference extracting unit 102 outputs the difference signal Δw (=0.4).

Next, the difference adding units 103a, 103b, 103c add the difference signal Δw to Rin, Gin, and Bin to output Rin+Δw, Gin+Δw, and Bin+Δw respectively.

In this case, an RGB value of Rin+Δw is 0, an RGB value of Gin+Δw is 0.7+0.4=1.1, and an RGB value of Bin+Δw is 1+0.4=1.4, as shown in FIG. 2(b).

The difference adding units 103a, 103b, 103c add the same difference signal Δw to the R signal Rin, the G signal Gin, and the B signal Bin respectively. Therefore brightness of the input RGB signal is increased by the value corresponding to the difference signal Δw.

Then, the brightness signal converting units 104, 105 perform the aforesaid matrix operation. Here, it is assumed that the matrix operation results in Y0=0.49, Y1=0.49+0.4=0.89. Then, the ratio detecting unit 108 detects the brightness ratio Ra as Ra=0.49/0.89 (=0.55).

Further, as shown in FIG. 2(c), the gain converting units 109a, 109b, 109c perform the gain conversion by multiplying Rin+Δw, Gin+Δw, and Bin+Δw by the brightness ratio Ra, respectively. As a result, gains Rvout, Gvout, and Bvout of Rout, Gout, and Bout are calculated as shown by the following expression 4.

Rvout=0, Gvout=1.1×0.55=0.61, Bvout=1.4×0.55=0.77 Expression 4

In the above-described manner, the color signal converting apparatus 100 converts the RGB values from (−0.4, 0.7, 1) to (0, 0.61, 0.77) to convert the saturation of the input RGB signal. As a result of this saturation conversion, the output RGB signal (Rout, Gout, Bout) falls within the color gamut of the display panel 510.

Thus, when the RGB value of one of Rin, Gin, and Bin is a negative value, the color signal converting apparatus 100 extracts a difference between this RGB value and the reference value “0” and thereafter clips this RGB value (the RGB value of Rin in the above-described embodiment) to “0”, and performs the saturation conversion in which the saturations of the other RGB color signals are lowered according to the extracted difference.

This saturation conversion lowers the saturation of the input RGB signal without changing a ratio of the RGB values, and therefore, causes no hue deviation, resulting in no hue change. Therefore, the color signal converting apparatus 100 is capable of converting a color signal without causing any hue change. Further, the color signal converting apparatus 100 is capable of controlling only saturation without causing any brightness deterioration.

### Second Embodiment of the Color Signal Converting Apparatus

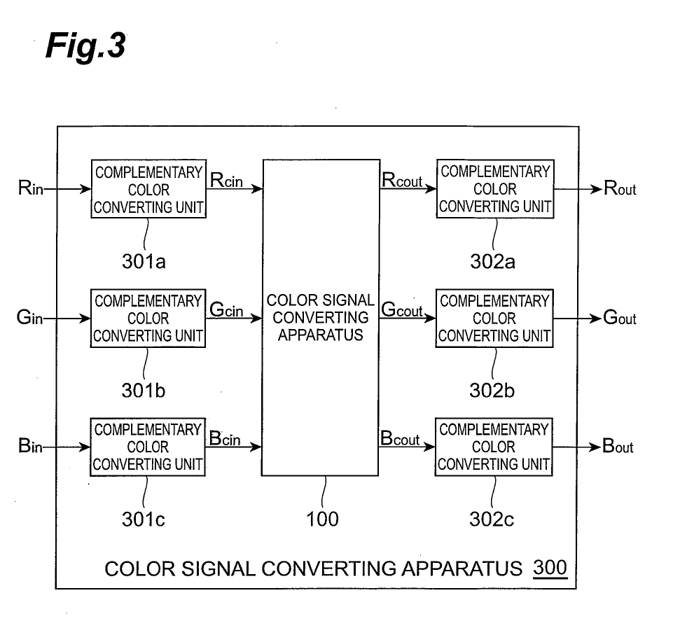

FIG. 3 is a block diagram showing the configuration of a color signal converting apparatus 300 according to a second embodiment. Similarly to the color signal converting apparatus 100, the color signal converting apparatus 300 is capable of converting a color signal even when an RGB value of one of an R signal, a G signal, and a B signal composing an RGB signal is larger than “1”.

In IEC61966-2-4:xvYCC, RGB signals include an RGB signal having an RGB value larger than “1” as well as an RGB signal having a negative RGB value. When an R signal, a G signal, or a B signal having an RGB value larger than “1” is included, the color signal converting apparatus 300 operates so as to clip the relevant RGB value to “1” by lowering saturation.

The color signal converting apparatus 300 has the same configuration as that of the color signal converting apparatus 100 except in that it has complementary color converting units 301a, 301b, 301c and complementary color converting units 302a, 302b, 302c.

The complementary color converting units 301a, 301b, 301c are disposed on a preceding stage of the color signal converting apparatus 100. The complementary color converting units 301a, 301b, 301c convert three input R signal (Rin), G signal (Gin), and B signal (Bin) into RGB complementary color signals respectively.

Complementary colors are colors producing achromatic white when added together. For example, 1−Rv can give a color signal of a complementary color of red (R). The complementary color converting units 301a, 301b, 301c perform a complementary color operation in which 1−Rv, 1−Gv, and 1−Bv are calculated respectively, and output the RGB complementary color signals respectively to the color signal converting apparatus 100. The RGB complementary color signals Rcin, Gcin, Bcin are input to the color signal converting apparatus 100.

The complementary color converting units 302a, 302b, 302c are disposed on a subsequent stage of the color signal converting apparatus 100. The complementary color converting units 302a, 302b, 302c have the same structure as that of the complementary color converting units 301a, 301b, 301c and perform the same complementary color operation as that performed by the complementary color converting units 301a, 301b, 301c.

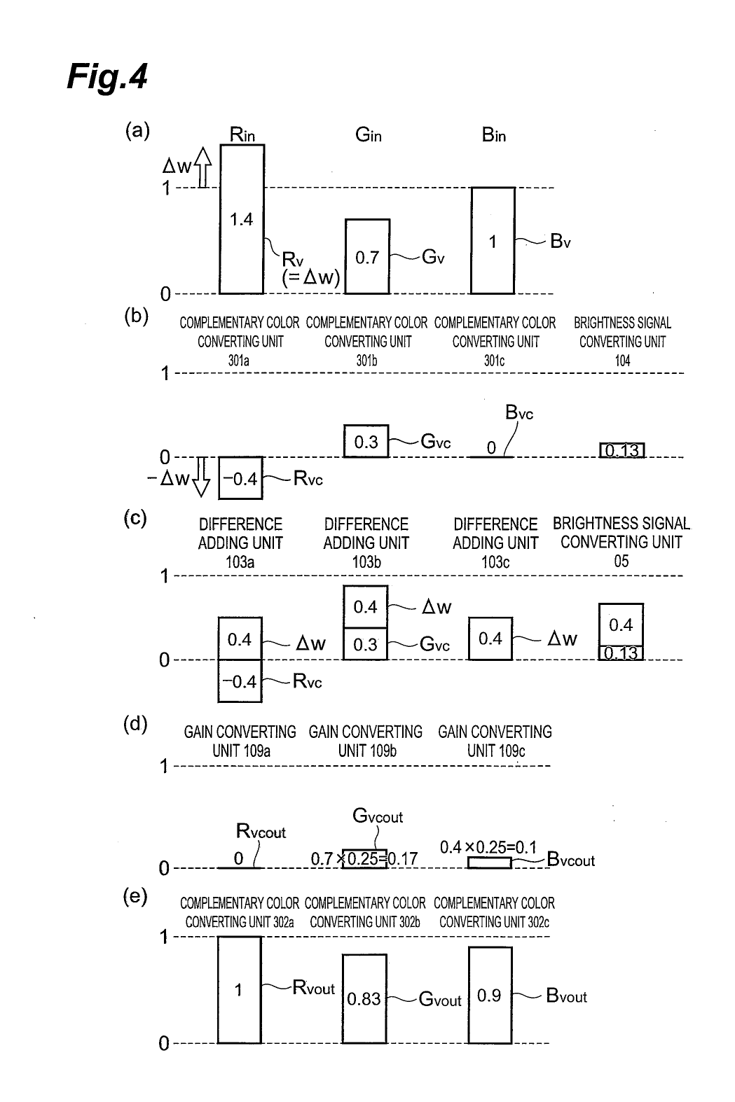

The operation contents of the color signal converting apparatus 300 as configured above will be described with reference to FIG. 4(a) to FIG. 4(e). FIG. 4(a) to FIG. 4(e) are views schematically showing an example of the operation contents of the color signal converting apparatus 300.

It is assumed that three R signal (Rin), G signal (Gin), B signal (Bin) as shown in FIG. 4(a) are input to the color signal converting apparatus 300. In this case, Rin has an RGB value Rv (=1.4) which is larger than 1. Further, Gin has a positive RGB value Gv (=0.7) and Bin has a positive RGB value Bv (=1).

At this time, the complementary color converting units 301a, 301b, 301c perform the complementary color operation in which 1−Rv, 1−Gv, and 1−Bv are calculated respectively, and input RGB complementary color signals to the color signal converting apparatus 100. In this case, an RGB value Rvc of an R complementary color signal is “−0.4”, an RGB value Gvc of a G complementary color signal is “0.3”, and an RGB value Bvc of a B complementary color signal is “0”.

Therefore, the RGB value Rvc of the R complementary color signal (Rcin) among the RGB complementary color signals input to the color signal converting apparatus 100 is negative. Accordingly, the color signal converting apparatus 100 performs the same saturation conversion as that of the first embodiment to output the RGB complementary color signals with lowered saturation.

In this case, in the color signal converting apparatus 100, Δw is added to Rvc, Gvc, and Bvc as shown in FIG. 4(c). Further, the saturation is converted according to a brightness ratio as shown in FIG. 4(d).

RGB values (Rvcout, Gvcout, Bvcout) of the RGB complementary color signals (Rcout, Gcout, Bcout) output from the color signal converting apparatus 100 are calculated by the following expression 5.

Rvcout=0, Gvcout=0.7×0.25=0.17, Bvcout=0.4×0.25=0.1 Expression 5

Then, the RGB complementary color signals (Rcout, Gcout, Bcout) are output from the color signal converting apparatus 100 and then are input to the complementary color converting units 302a, 302b, 302c respectively.

Since the complementary color converting units 302a, 302b, 302c perform the same complementary color conversion as that performed by the complementary color converting units 301a, 301b, 301c, the RGB complementary color signals are converted into RGB signals by the complementary color converting units 302a, 302b, 302c.

In the above-described manner, the RGB signals (Rout, Gout, Bout) having performed the saturation conversion are output from the complementary color converting units 302a, 302b, 302c. The RGB signals have the RGB values (Rvout, Gvout, Bvout) as shown in FIG. 4(e).

As described above, according to the color signal converting apparatus 300, when the RGB value Rvc of Rin is larger than “1”, the complementary color conversion by the complementary color converting units 301a, 301b, 301c is performed. Therefore, in the color signal converting apparatus 100 disposed on the subsequent stage of the complementary color converting units 301a, 301b, 301c, the RGB complementary color signal whose RGB value is changed to a negative value is input, and accordingly, the color signal converting apparatus 100 performs the same saturation conversion as that of the first embodiment to output the RGB complementary color signal whose RGB value is clipped to “0”. Then, the complementary color converting units 302a, 302b, 302c on the subsequent stage perform the complementary color conversion again to output the RGB signals.

In this manner, even when the RGB value is larger than “1”, the color signal converting apparatus 300 is capable of performing the saturation conversion by using the color signal converting apparatus 100 as it is since it is provided with the complementary color converting units on the preceding stage and on the subsequent stage of the color signal converting apparatus 100. The color signal converting apparatus 300, similarly to the color signal converting apparatus 100, lowers the saturation of the input RGB signal without changing a ratio of the RGB values, which can prevent the occurrence of hue deviation, resulting in no hue change. Further, the color signal converting apparatus 300, similarly to the color signal converting apparatus 100, can control only saturation without causing any brightness deterioration.

### Third Embodiment of the Color Signal Converting Apparatus

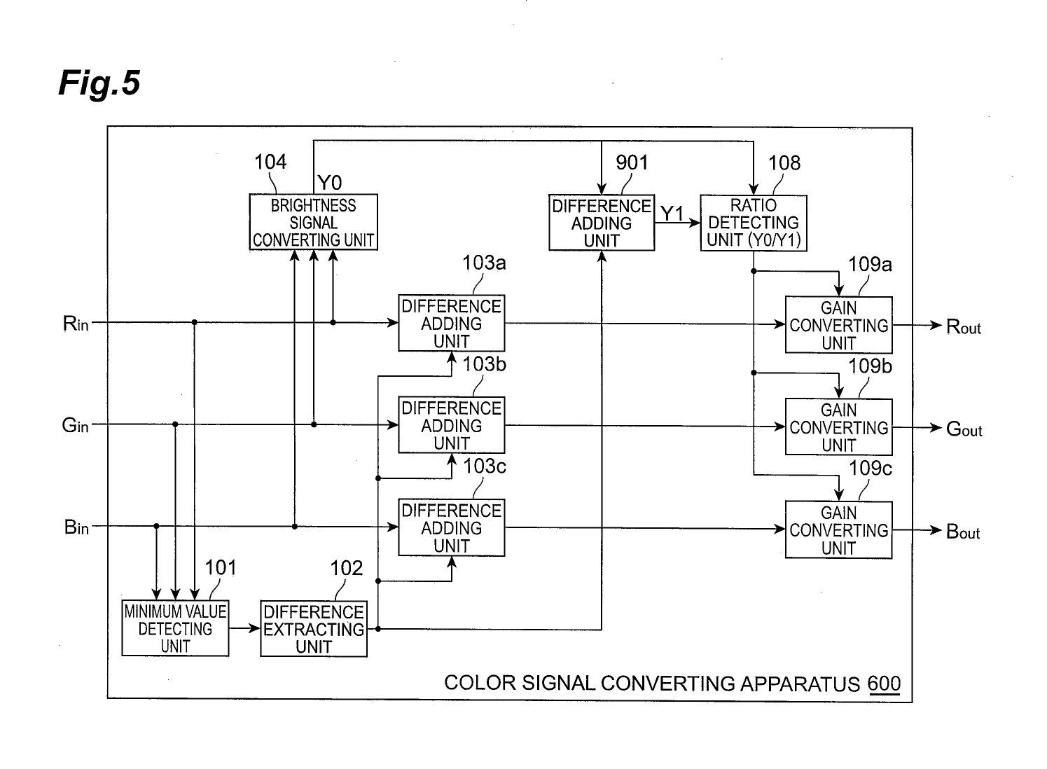

FIG. 5 is a block diagram showing the configuration of a color signal converting apparatus 600 according to a third embodiment. The color signal converting apparatus 600 has the same configuration as that of the color signal converting apparatus 100 except in that it has a difference adding unit 901 in place of the brightness signal converting unit 105.

The difference adding unit 901 is formed by the same adder as the difference adding units 103a, 103b, 103c.

In the color signal converting apparatus 100, the brightness signal Y1 is calculated by the matrix operation as described above. As shown in the expression 6, it is possible to calculate the brightness signal Y1 by increasing brightness by adding a difference signal Δw to a brightness signal Y0.

Y1=Ka×(Rv+Δw)+Kb×(Gv+Δw)+Kc×(Bv+Δw)=Ka×Rv+Kb×Gv+Kc×Bv+(Ka+Kb+Kc)×Δw=Y0+Δw Expression 6

In consideration of this, in the color signal converting apparatus 600, the brightness signal converting unit 105 is replaced by the difference adding unit 901.

The difference adding unit 901 is provided for calculating the brightness signal Y1. Specifically, the difference adding unit 901 calculates the brightness signal Y1 by adding the brightness signal Y0 output from a brightness signal converting unit 104 and the difference signal Δw output from a difference extracting unit 102. Then, the difference adding unit 901 outputs the brightness signal Y1 to a ratio detecting unit 108.

As for the other operation, the color signal converting apparatus 600 operates in the same manner as the color signal converting apparatus 100 to perform saturation conversion. Therefore, when an RGB value of any of an R signal, a G signal, and a B signal composing an RGB signal is smaller than “0”, the color signal converting apparatus 600 clips this RGB value to “0” and performs the saturation conversion so as to lower the saturations of the other two colors as well according to the difference.

In this manner, similarly to the color signal converting apparatus 100, the color signal converting apparatus 600 lowers the saturation of the input RGB signal without changing a ratio of the RGB values, which can prevent the occurrence of hue deviation, resulting in no hue change. Further, similarly to the color signal converting apparatus 100, the color signal converting apparatus 600 is capable of controlling only saturation without causing any brightness deterioration.

Further, in the color signal converting apparatus 100, the brightness signal converting units 104, 105 using adders for the matrix operation are provided, but in the color signal converting apparatus 600, the difference adding unit 901 is provided in place of the brightness signal converting unit 105. Therefore, the color signal converting unit 600 has a less number of the adders than the color signal converting apparatus 100, which can reduce circuit scale.

### First Embodiment of a Video Display Apparatus

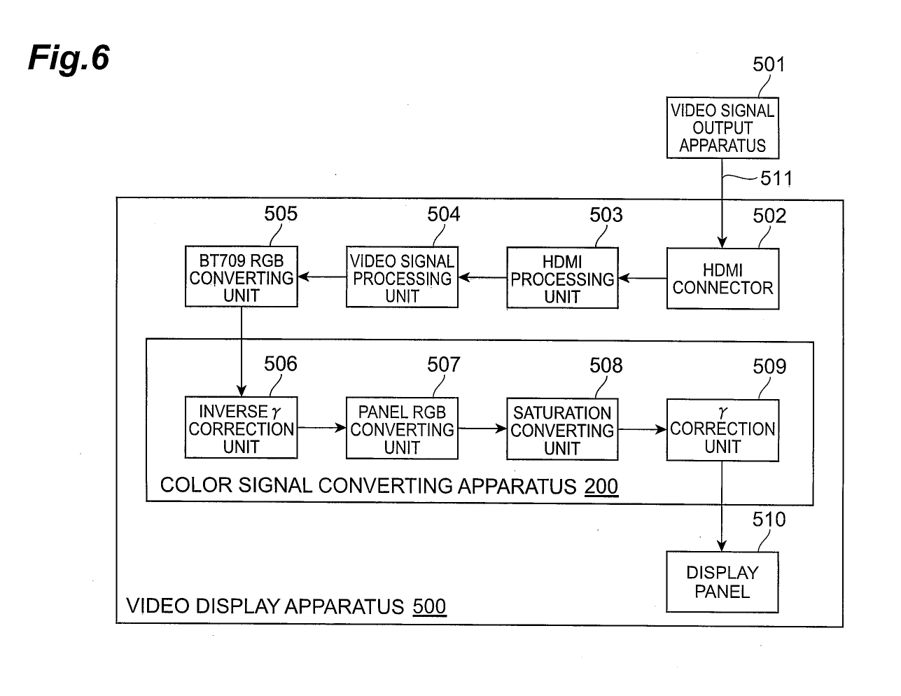

Next, an embodiment of a video display apparatus 500 including an HDMI connector will be described. FIG. 6 is a block diagram showing the configuration of the video display apparatus 500. The video display apparatus 500 has an HDMI connector 502, an HDMI processing unit 503, and a video signal processing unit 504. The video display apparatus 500 further has a BT709RGB converting unit 505, a color signal converting apparatus 200, and a display panel 510, and also has a function (not shown) of receiving a television broadcast to display video.

The HDMI connector 502 receives a video signal compliant with the HDMI standard (HDMI signal) which is generated in the xvYCC standard, from a video signal output apparatus 501 such as a video camera or a DVD recorder via an HDMI cable 511 and outputs the HDMI signal to the HDMI processing unit 503.

The HDMI processing unit 503 is compliant with the HDMI ver1.3 standard. The HDMI processing unit 503 processes the input HDMI signal to separate an information packet, separates and reproduces an HDMI-audio signal, and separates an HDMI-video signal. Here, the HDMI-video signal is a video signal in the YCbCr format (Y is a brightness signal and CbCr are color difference signals) of BT709 or BT601 and is output to the video signal processing unit 504.

The video signal processing unit 504 performs scaling in which the HDMI-video signal is converted so as to be compliant with a size format of the display panel 510. Further, if the HDMI-video signal is an interlace signal, the video processing unit 504 performs progressive scan conversion to convert the interlace signal to a non-interlace signal. HDMI-video signals differ in size format and the like, and the scaling is intended to enable the display of such HDMI-video signals on the display panel 510. A video signal in the YCbCr format is output from the video signal processing unit 504.

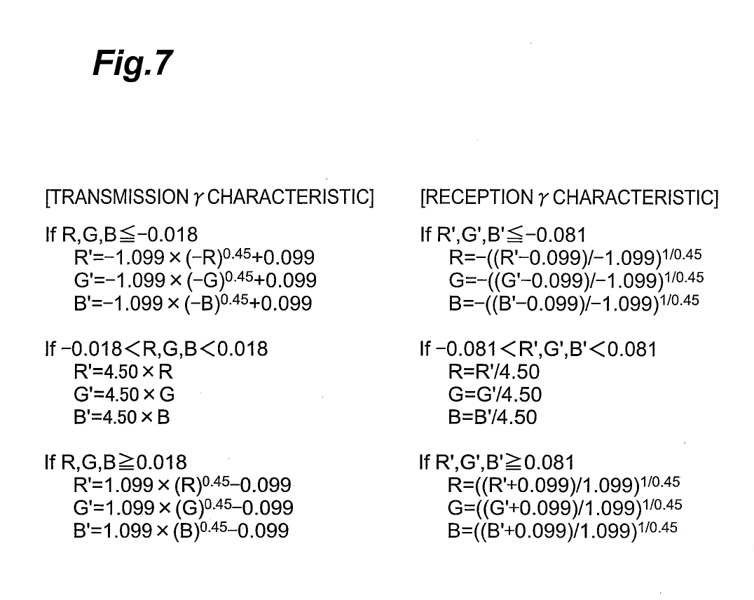

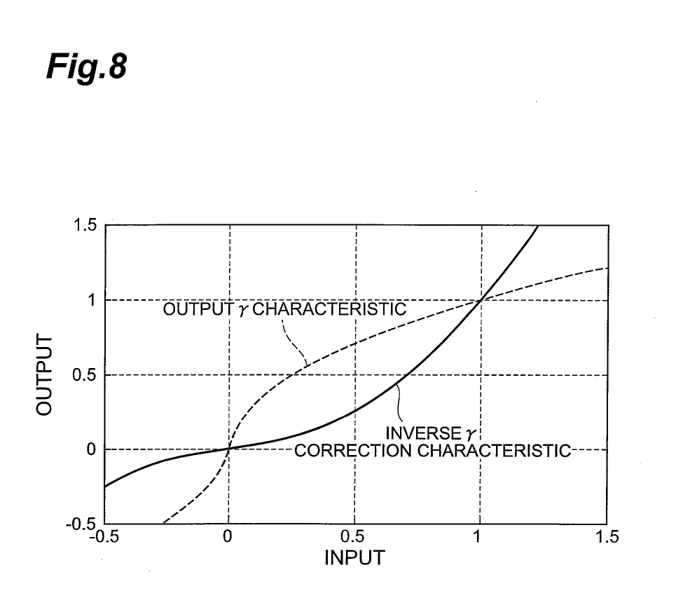

The BT709RGB converting unit 505 converts the video signal in the YCbCr format to an RGB signal of BT709 primaries. γ (gamma) correction has been applied to the RGB signal obtained here, by the video signal output apparatus 501 according to arithmetic expressions for a transmission γ characteristic shown in FIG. 7. The dotted line in FIG. 8 shows a characteristic of the γ correction (output γ characteristic).

The color signal converting apparatus 200 has an inverse γ correction unit 506, a panel RGB converting unit 507, a saturation converting unit 508, and a γ correction unit 509.

According to the arithmetic expressions for a reception γ characteristic shown in FIG. 7, the inverse γ correction unit 506 applies inverse γ correction in which an inverse characteristic to the transmission characteristic is rendered to the RGB signal of the BT709 primaries. The solid line in FIG. 8 shows the inverse γ correction characteristic. The inverse γ correction by the inverse γ correction unit 506 cancels the γ correction which has been applied to the RGB signal, and as a result, the RGB signal with a linear characteristic is obtained.

The panel RGB converting unit 507 converts the linear RGB signal of the BT709 primaries into a linear RGB signal of the panel primaries of the display panel 510 (this conversion is also called panel RGB conversion). The panel RGB conversion converts a color signal in an extended color gamut transmitted in xvYCC (the RGB signal input to the color signal converting apparatus 200) into an RGB signal falling within a color gamut of the display panel 510. Incidentally, the color gamut of the display panel 510 is larger than a color gamut defined by the BT709 standard, and a color gamut of the video signal output apparatus 501 is larger than the color gamut of the display panel 510, though not shown.

Since the color gamut of the video signal output apparatus 501 is wider than the color gamut of the display panel 510, any one color signal out of an R signal, a G signal, and a B signal, which is out of the color gamut of the display panel 510, is clipped so that the color signal falls within the color gamut of the display panel 510. As a result, an RGB ratio changes to cause a hue change, the saturation converting unit 508 is provided.

The saturation converting unit 508 has the same configuration as that of the above-described color signal converting apparatus 100. The saturation converting unit 508 performs the saturation conversion in order to prevent hue deviation and hue change which may occur when the linear RGB signal of the panel primaries has a negative value or has a value larger than “1”. This saturation conversion is the same as those described in the first embodiment to the third embodiment of the color signal converting apparatus.

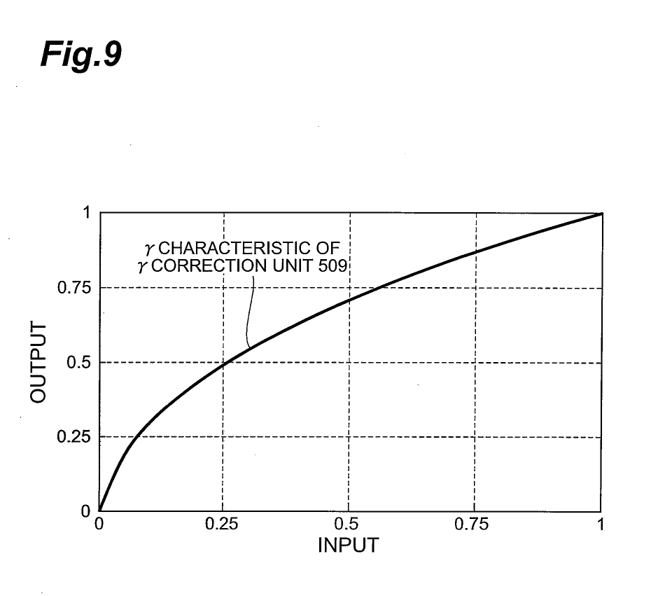

According to the γ characteristic shown in FIG. 9, the γ correction unit 509 applies the γ correction to the RGB signals (Rout, Bout, Gout) output from the saturation converting unit 508. The display panel 510 displays video by liquid crystal display by using the RGB signals having undergone the γ correction.

As described above, the video display apparatus 500 has the color signal converting apparatus 200. The color signal converting apparatus 200 has the saturation converting unit 508 with the same configuration as that of the color signal converting apparatus 100. Therefore, when an RGB value of one of the R signal (Rin), the G signal (Gin), and the B signal (Bin) input to the saturation converting unit 508 is negative, the color signal converting apparatus 200 lowers saturation without changing a ratio of the RGB values.

Therefore, in the video display apparatus 500, the saturation converting unit 508 lowers the saturation of the RGB signal without changing a ratio of the RGB values by performing the saturation conversion before the display panel 510 displays the corresponding video. Therefore, it is possible to display on the display panel 510 vivid video with no hue deviation and no hue change.

Further, in the case where a color signal has performed the γ correction, the occurrence of hue deviation could be prevented by the saturation conversion without canceling the γ correction. However, the saturation conversion, if performed without canceling the γ correction, would result in a brightness change, which is not the case with the color signal exhibiting a linear characteristic, and the saturation conversion could not be performed appropriately.

Therefore, in the color signal converting apparatus 200, the inverse γ correction unit 506 is disposed on a preceding stage of the saturation converting unit 508, and the saturation converting unit 508 detects a minimum value signal among the color signals to which the inverse γ correction has been applied by the inverse γ correction unit 506, and performs the saturation conversion. That is, the color signals to which the γ correction has been applied are subjected to the saturation conversion by the inverse γ correction unit 506 after the γ correction is canceled, which enables the appropriate saturation conversion.

Incidentally, if the saturation converting unit 508 has the same configuration as that of the color signal converting apparatus 300, it is capable of lowering the saturation without changing a ratio of the RGB values when an RGB value of one of the input R signal, G signal, and B signal is larger than “1”.

### Second Embodiment of the Video Display Apparatus

The video display apparatus 500 may have a color signal converting apparatus 201 or may have a color signal converting apparatus 202 in place of the color signal converting apparatus 200.

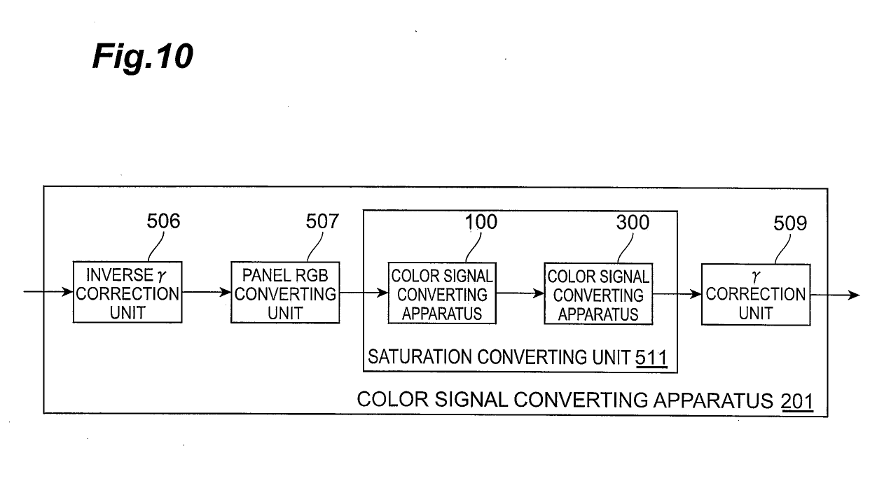

The color signal converting apparatus 201 is different from the color signal converting apparatus 200 in that it has a saturation converting unit 511 in place of the saturation converting unit 508 as shown in FIG. 10. The saturation converting unit 511 has the color signal converting apparatus 100 and the color signal converting apparatus 300 which are described above, and the color signal converting apparatus 300 is disposed on a subsequent stage of the color signal converting apparatus 100.

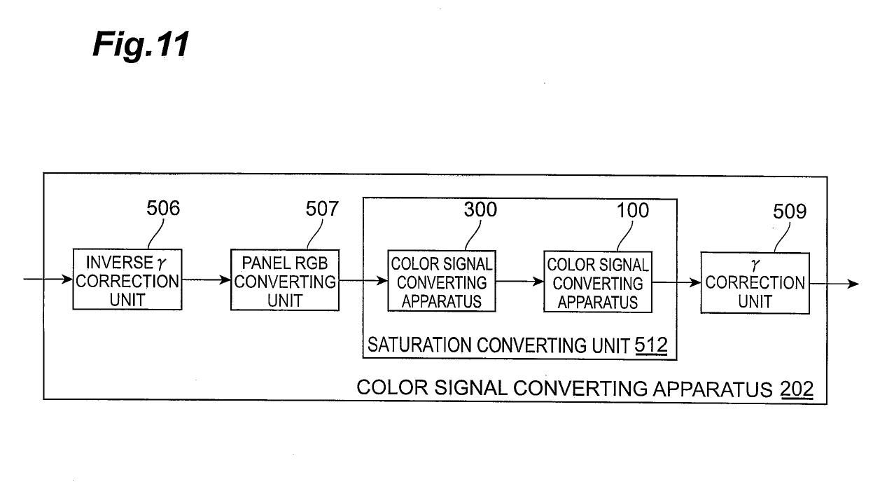

Further, as shown in FIG. 11, the color signal converting apparatus 202 is different from the color signal converting apparatus 200 in that it has a saturation converting unit 512 in place of the saturation converting unit 508. The saturation converting unit 512 has the above-described color signal converting apparatus 100 and color signal converting apparatus 300, and the color signal converting apparatus 100 is disposed on a subsequent stage of the color signal converting apparatus 300.

Since the saturation converting unit 511 and the saturation converting unit 512 each have the color signal converting apparatus 100 and the color signal converting apparatus 300, it is possible to prevent the occurrence of hue deviation by performing the saturation conversion of both an RGB signal with a negative RGB value and an RGB signal with an RGB value larger than “1”.

However, in view of the size relation among the color gamut defined by the BT709 standard, the color gamut of the display panel 510, and the color gamut of the video signal output apparatus 501, the number of RGB signals having an RGB value larger than “1” is smaller than the number of RGB signals having a negative RGB value. Therefore, it is more preferable that the color signal converting apparatus 100 handling RGB signals having a negative RGB value is disposed on a preceding stage of the color signal converting apparatus 300 (in the above-described case, the saturation converting unit 511).

The forgoing description is the description of the embodiments of the invention and is not intended to limit apparatuses and methods of the invention, and various modified examples can be easily embodied. Further, an apparatus or a method realized by appropriate combination of the constituent elements, functions, features, or method steps in the embodiments are also included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A color signal converting apparatus comprising:
a minimum value detecting section detecting a minimum value signal having a smallest value among a plurality of input color signals;
a difference extracting section extracting a difference between the minimum value signal detected by said minimum value detecting section and a reference value;
a difference adding section adding the difference extracted by said difference extracting section to each of the plural color signals; and
a saturation converting section converting saturation of each of the plural color signals to which the difference is added, according to a ratio of brightness of the plural input color signals and brightness of the plural color signals to which the difference is added by said difference adding section.

2. The color signal converting apparatus according to claim 1, wherein said difference extracting section outputs a difference signal indicating an absolute value of the extracted difference when the difference is a negative value, and outputs a difference signal indicating a zero value when the difference is a positive value.

3. The color signal converting apparatus according to claim 1, further comprising:
a first brightness signal converting section converting the plural input color signals into a brightness signal; and
a second brightness signal converting section converting the plural color signals to which the difference is added, into a brightness signal, and
wherein said saturation converting section converts the saturation according to a ratio of brightness of the brightness signal converted by said first brightness signal converting section and brightness of the brightness signal converted by said second brightness signal converting section.

4. The color signal converting apparatus according to claim 1, further comprising:
a brightness signal conversing section converting the plural input color signals into a brightness signal; and
a brightness signal difference adding section adding the difference extracted by said difference extracting section to the brightness signal converted by said brightness signal converting section, and
wherein said saturation converting section converts the saturation according to a ratio of brightness of the brightness signal converted by said brightness signal converting section and brightness of the brightness signal to which the difference is added by said brightness signal difference adding section.

5. The color signal converting apparatus according to claim 1, further comprising:
a first complementary color converting section converting the plural input color signals into complementary color signals; and
a second complementary color converting section converting the plural color signals whose saturations have been converted by said saturation converting section, into complementary color signals.

6. The color signal converting apparatus according to claim 1, further comprising:
an inverse γ correction section applying inverse γ correction to the plural color signals; and
a γ correction section applying γ correction to the plural color signals, and
wherein said minimum value detecting section detects the minimum value signal among the plural color signals to which the inverse γ correction is applied by said inverse γ correction section, and said γ correction section applies the γ correction to the plural color signals whose saturations are converted by said saturation converting section.

7. The color signal converting apparatus according to claim 6, further comprising
an RGB converting section converting the plural color signals to which the inverse γ correction is applied by said inverse γ correction section, into RGB signals of display panel primaries, and
wherein said minimum value detecting section detects the minimum value signal among the RGB signals converted by said RGB converting section.

8. A video display apparatus comprising:
a video display panel displaying video;
a video signal processing section applying signal processing appropriate for said video display panel to an input video signal;
an RGB signal converting section converting the video signal processed by said video signal processing section, into an RGB signal; and
a color signal converting section applying conversion processing to the RGB signal converted by said RGB signal converting section, and
said color signal converting section comprising:
a minimum value detecting section detecting a minimum value signal having a smallest value in the input RGB signal;
a difference extracting section extracting a difference between the minimum value signal detected by said minimum value detecting section and a reference value;
a difference adding section adding the difference extracted by said difference extracting section to each of RGB color signals composing the RGB signal; and
a saturation converting section converting saturation of each of the RGB color signals to which the difference is added, according to a ratio of brightness of the input RGB signal and brightness of the RGB color signals to which the difference is added by said difference adding section.

9. A color signal converting method comprising:
detecting a minimum value signal having a smallest value among a plurality of input color signals;
extracting a difference between the detected minimum value signal and a reference value;
adding the extracted difference to each of the plural color signals; and
converting saturation of each of the plural color signals to which the difference is added, according to a ratio of brightness of the plural input color signals and brightness of the plural color signals to which the difference is added.
